(19) United States
(12) Patent Application Publication
(10) Pub. No.: US 2026/0189823 A1
(43) Pub. Date: Jul. 2, 2026

(54) NETWORK INTERFACE DEVICE

(71) Applicant: CenturyLink Intellectual Property LLC, Denver, CO (US)

(72) Inventors: Susan CHANDLER, Parker, CO (US); Shaun HAWKINSON, Saint Paul, MN (US); Anthony ANDREWS, Rancho Santa Margarita, CA (US)

(73) Assignee: CenturyLink Intellectual Property LLC, Denver, CO (US)

(21) Appl. No.: 19/364,745

(22) Filed: Oct. 21, 2025

Related U.S. Application Data
(60) Provisional application No. 63/740,117, filed on Dec. 30, 2024.

(51) Int. Cl. H04Q 1/02

(52) U.S. Cl. CPC H04Q 1/028; H04Q 1/035

(57) ABSTRACT

The present application describes a network interface device that includes a housing, legs disposed on the housing, and keyholes each disposed in a respective leg. The housing may include one or more ports for wired connection. The housing may include a top indented surface to receive another same or similar network interface device. The housing may include first and second bottom indented surfaces, the second more indented than the first. The legs may be disposed on the first bottom indented surface and may extend so as to create a gap between a surface that the network interface device is disposed on and the network interface device itself. The keyholes allow for the network interface device to be mounted on a vertical surface (e.g., a wall) and/or to be secured on a stand.

### CROSS-REFERENCE TO RELATED APPLICATIONS

This application claims the benefit of U.S. Provisional Application No. 63/740,117 filed December 30, 2024, entitled “Network Interface Device, which is incorporated herein by reference in its entirety.

### BACKGROUND

Network interface devices are physical connection points between a telecommunications carrier's network and a customer's premises. Network interface devices support various connection types, including copper and fiber optic cables. Network interface devices have different physical designs to accommodate various purposes.

### SUMMARY

The present application describes a network interface device according to one aspect. The network interface device comprises a housing comprising a top housing portion and a bottom housing portion opposite the first housing portion, wherein the top housing portion comprises a top indented surface, a plurality of legs disposed on the bottom housing portion, and a plurality of keyholes, wherein each keyhole of the plurality of keyholes is disposed in a respective leg of the plurality of legs.

In some examples, a leg plane defined as tangential to a most distal portion of at least one leg of the plurality of legs is separated by a gap from a bottom plane defined as tangential to a bottom surface of the bottom housing portion.

In some examples, the bottom housing portion comprises a plurality of bottom air vents, and the housing further comprises a side housing portion comprising a plurality of side air vents.

In some examples, the housing further comprises a pocket indented in a side housing portion of a side housing portion, and a plurality of openings for communication ports are disposed in the pocket.

In some examples, each of the keyholes comprises a first keyhole portion and a second keyhole portion, wherein each first keyhole portion is larger than each second keyhole portion, and wherein each first keyhole portion is disposed closer to the pocket than its respective second keyhole portion for all of the keyholes.

In some examples, the bottom housing portion comprises a bottom surface, a first bottom indented surface indented in the housing, and a second bottom indented surface indented in the housing more than the first bottom indented surface.

In some examples, the plurality of legs are disposed on the first bottom indented surface.

In some examples, each of the keyholes comprises a first keyhole portion and a second keyhole portion, wherein each first keyhole portion is larger than each second keyhole portion, and wherein all keyholes are oriented in a same direction such that the first keyhole portion is disposed on a same side of its respective second keyhole portion.

In some examples, the top indented surface is indented from a most-distal portion of the top housing portion by a first distance, and wherein the legs extend farther from the bottom plane than the first distance.

In some examples, the network interface device comprises circuitry and at least one fan configured to cool the circuitry.

In some examples, a cavity is disposed behind each keyhole of the plurality of keyholes, and wherein each cavity is defined at least partially by the respective leg in which the keyhole is disposed.

In some examples, a perimeter defined by the plurality of legs is smaller than a perimeter of the top indented portion.

According to another aspect, the present disclosure describes a network interface device, comprising a housing comprising a bottom surface, a first bottom indented surface indented in the housing, and a second bottom indented surface indented in the housing more than the first bottom indented surface, a plurality of legs disposed on the first bottom indented surface, and a plurality of keyholes, wherein each keyhole of the plurality of keyholes is disposed in a respective leg of the plurality of legs.

In some examples, a leg plane defined as tangential to a most distal portion of at least one leg of the plurality of legs is separated by a gap from a bottom plane defined as tangential to a bottom surface of the bottom housing portion.

In some examples, a bottom housing portion of the housing comprises a plurality of bottom air vents, the bottom housing portion comprises the bottom surface, the first bottom indented surface, and the second bottom indented surface, and the plurality of bottom air vents is adjacent to the second bottom indented surface.

In some examples, the housing further comprises a side housing portion comprising a plurality of side air vents.

According to another aspect, the present disclosure describes a network interface device, comprising a housing, a plurality of communication ports disposed on the housing, a plurality of legs disposed on the housing, and a plurality of keyholes, wherein each keyhole of the plurality of keyholes is disposed on a respective bottom leg surface of a respective leg of the plurality of legs.

In some examples, a leg plane defined as tangential to a most distal portion of at least one leg of the plurality of legs is separated by a gap from a bottom plane defined as tangential to a bottom surface of the housing.

In some examples, a plurality of openings for the communication ports are disposed in a pocket in a side housing portion of the housing.

In some examples, the plurality of legs are disposed on a first bottom indented surface of the housing.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an example environment that may include a network interface device according to an example.

FIG. 2 illustrates components of a network interface device according to an example.

FIG. 3 illustrates an isometric view of a network interface device according to an example.

FIG. 4 illustrates a different isometric view of a network interface device according to an example.

FIG. 5 illustrates a bottom view of a network interface device according to an example.

FIG. 6 illustrates a side view of a network interface device according to an example.

FIG. 7 illustrates an isometric view of a network interface device and stand according to an example.

FIG. 8 illustrates another isometric view of a network interface device and stand according to an example.

FIG. 9 illustrates a rear view of a network interface device and stand according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Network interface devices are physical connection points between a telecommunications carrier's network and a customer's premises. Network interface devices support various connection types, including copper and fiber optic cables. Network interface devices have different physical designs to accommodate various purposes. However, existing network interface devices often exhibit limitations in terms of physical placement and orientation due to their limited physical design, restricting their adaptability to various installation environments. Such constraints can hinder efficient deployment and utilization of these devices, particularly in scenarios where space is limited or where specific mounting or positioning requirements exist. Consequently, a need exists for a network interface device that overcomes these limitations by offering increased flexibility in placement and orientation, thereby enhancing its applicability across a wider range of installation conditions.

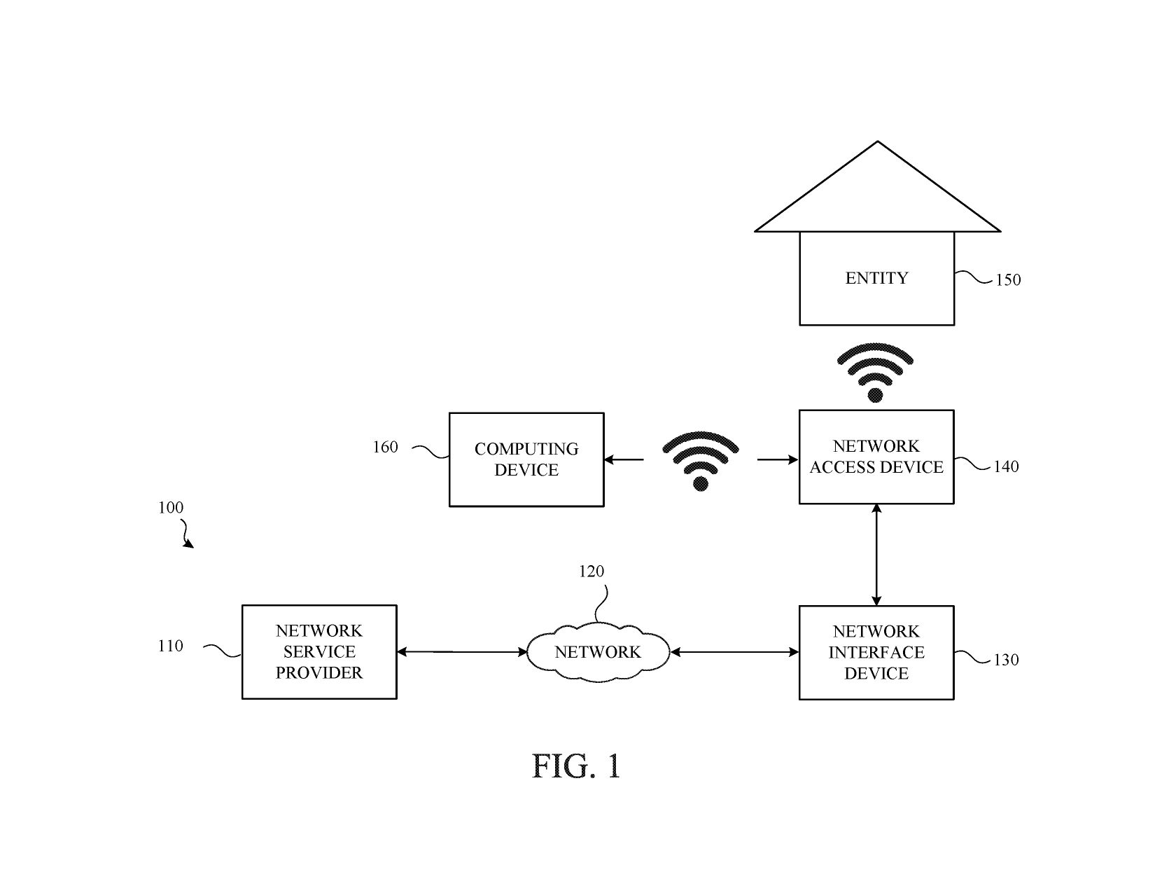

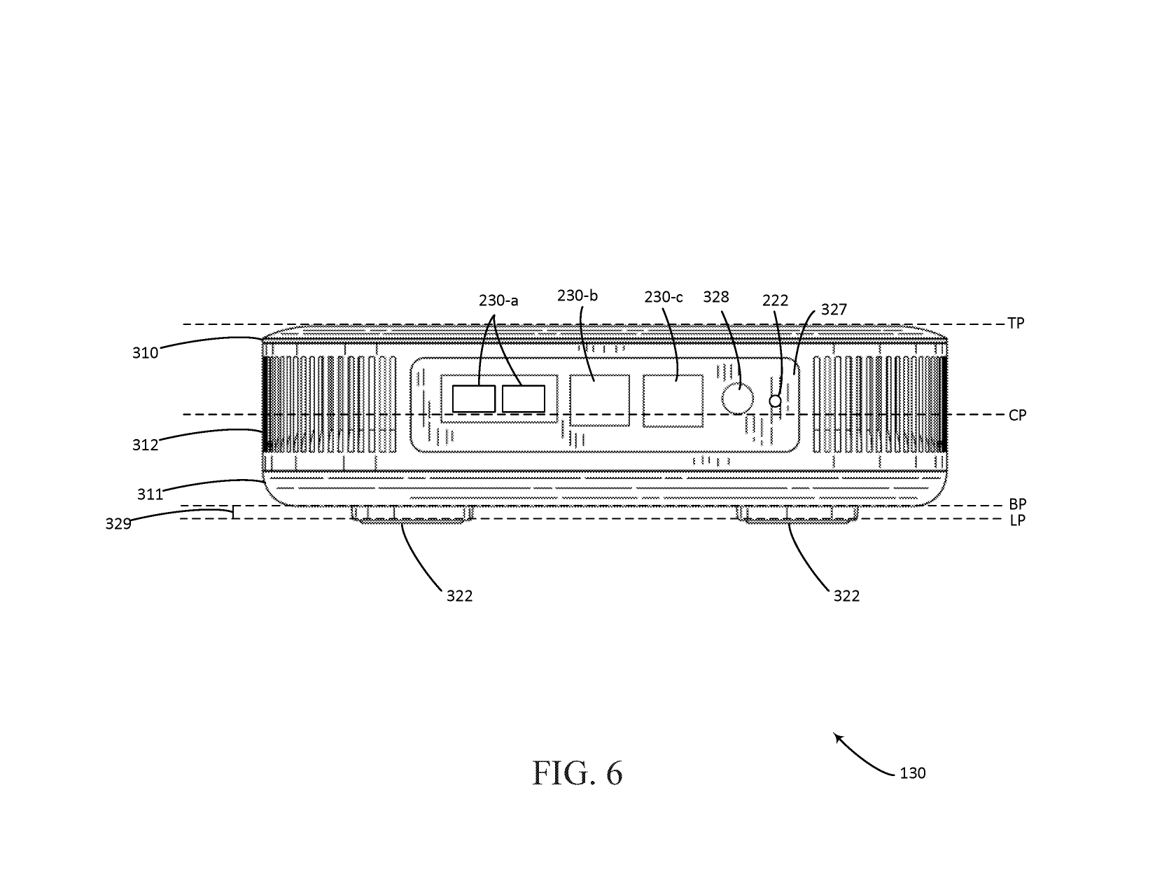

Examples are provided herein for a network interface device with an improved design, offering more streamlined and increased flexibility in placement and orientation, among other benefits. In some examples, the network interface device includes a housing, legs disposed on the housing, and keyholes each disposed in a respective leg. The housing may include one or more ports for wired connection. The housing may include a top indented surface to support another same or similar network interface device. The housing may include first and second bottom indented surfaces, the second more indented than the first. The legs may be disposed on the first bottom indented surface and may extend so as to create a gap under the network interface device in order to facilitate improved airflow. The second bottom indented surface may include bottom air vents. The keyholes may allow for the network interface device to be placed flat, mounted on a surface (e.g., a vertical surface) (e.g., a wall), and/or to be secured on a stand. As such, the network interface device is capable of lying flat/horizontally, being hung on a vertical surface, or being secured on a stand, depending on the desired orientation. Additionally, the network interface device is capable of stacking with multiple other components, such as other same or similar network interface devices, or other components (e.g., storage devices, other network devices such as routers) while remaining securely in place and providing space for enough airflow to cool internal components. These and other examples will be explained in more detail below with respect to FIG. 1 – FIG. 6.

FIG. 1 illustrates an example environment 100 that may include a network interface device 130 according to an example. The network interface device 130 may be provided by or otherwise be associated with a network service provider 110. The network service provider 110 may provide network access, via network 120, to the network interface device 130. For example, the network service provider 110 may provide fiber-optic cable, copper cable, and/or other physical links/circuits that enable customers to access the network 120 via the network interface device 130. The network interface device 130 may serve as an interface between the cables/wiring provided by the network service provider and the on-premises wiring of an entity 150. An entity 150 may be a home, a business or other entity for which network access is desired.

Once the network interface device 130 has been coupled to the network 120 (e.g., via a wide area network (WAN) port associated with the network interface device 130), network access may be provided to the entity 150 via a network access device 140. The network access device 140 may be communicatively coupled to the network interface device 130 via an ethernet port provided in the network interface device 130. The network access device 140 may be a mesh network device, a router or other such network device that provides wired and/or wireless network access to one or more computing devices associated with the entity 150. The network access device 140 may also wirelessly communicate with a computing device 160. The computing device 160 may be a computing device of a network technician, of a customer of the network service provider, or otherwise be associated with the entity 150. In some examples, a technician may be able to remotely access network interface device 130 for troubleshooting, diagnostics, set up, or the like.

In some examples, the network interface device 130 does not have native wireless capabilities but is able to support network access devices 140 that utilize different Wi-Fi versions. For example, the network interface device 130 may be compatible with a network access device 140 that supports Wi-Fi version 5, a network access device 140 that supports Wi-Fi version 6, and/or a network access device 140 that supports Wi-Fi version 7. Although specific Wi-Fi versions are mentioned, these are for example purposes only. In some examples, the network access device 140 may support other wireless communication standards such as, for example, mobile communications and/or LTE.

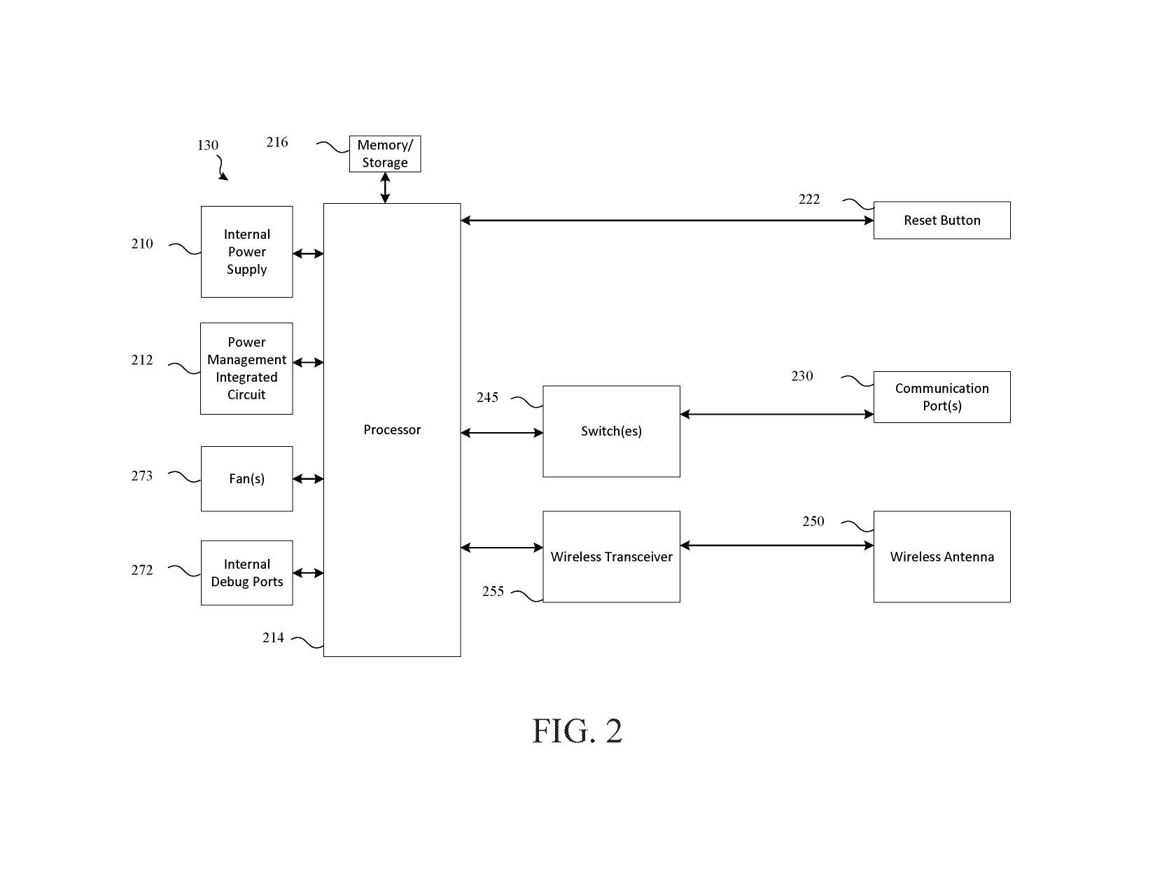

FIG. 2 illustrates components of a network interface device 130 according to an example.

The network interface device 130 may include an internal power supply 210. The internal power supply 210 enables the network interface device 130 to support a power cable. An example outlet for the power cable is shown in FIG. 6 as power port 328. Because the power supply 210 is internal to the network interface device 130, the power cable may be connected directly from the power port 328 to an electrical outlet associated with an entity (e.g., entity 150 (FIG. 1)) without using a power brick. In examples, the internal power supply 210 is operatively connected through a power-management integrated circuit 212 to a processor 214. In the example shown, the processor 214 is a system on a chip design adapted to work as a network gateway/router. Processor 214 may also be operatively connected to memory/storage 216, which may comprise random access memory (RAM), synchronous dynamic RAM (SDRAM), non-volatile (e.g. read-only memory (ROM)), flash memory, or any combination thereof, or other electronic storage capable of storing data, instructions, or other information that may be used by the processor 214 to perform one or more of the aspects of the present application.

Memory/storage 216 may also comprise, but is not limited to, an operating system, one or more program instructions, and may include sufficient computer-executable instructions, which when executed, perform functionalities as described herein. The operating system, for example, may be suitable for controlling the operation of processor 214. Furthermore, aspects may be practiced in conjunction with a graphics library, other operating systems, or any other application program and is not limited to any particular application or system. Network interface device 130 may also include additional data storage devices (removable or non-removable). Programming modules stored in memory/storage 216 may include routines, programs, components, data structures, and other types of structures that may perform particular tasks or that may implement particular abstract data types. Moreover, aspects may be practiced with other computer system configurations, including hand-held devices, multiprocessor systems, microprocessor-based or programmable user electronics, minicomputers, mainframe computers, and the like. Furthermore, aspects may be practiced in an electrical circuit comprising discrete electronic elements, packaged or integrated electronic chips containing logic gates, a circuit using a microprocessor, or on a single chip containing electronic elements or microprocessors (e.g., a system-on-a-chip (SoC)). Aspects may also be practiced using other technologies capable of performing logical operations such as, for example, AND, OR, and NOT, including, but not limited to, mechanical, optical, fluidic, and quantum technologies. In addition, aspects may be practiced within a general purpose computer or in any other circuits or systems.

Although aspects have been described as being associated with data stored in memory and other storage mediums, data can also be stored on or read from other types of computer-readable media, such as secondary storage devices, like hard disks, floppy disks, flash drives, or a CD-ROM, or other forms of RAM or ROM. The term computer-readable storage medium refers only to nontransitory devices and articles of manufacture that store data or computer-executable instructions readable by a computing device. The term computer-readable storage media does not include computer-readable transmission media.

Aspects of the present invention may be used in various distributed computing environments where tasks are performed by remote processing devices that are linked through a communications network. Aspects of the invention may be implemented via local and remote computing and data storage systems. Such memory storage and processing units may be implemented in a computing device. Any suitable combination of hardware, software, or firmware may be used to implement the memory storage and processing unit. For example, the memory storage and processing unit may be implemented with network interface device 130 or any other computing devices, in combination with network interface device 130, wherein functionality may be brought together over a network in a distributed computing environment, for example, an intranet or the Internet, to perform the functions as described herein. The systems, devices, and processors described herein are provided as examples; however, other systems, devices, and processors may comprise the aforementioned memory storage and processing unit, consistent with the described aspects.

In examples, one or more communication ports 230 may be operatively connected to processor 214 through one or more switching devices 245. Communication ports 230 are described later with respect to FIG. 6.

The network interface device 130 may also include communication system that enables the network interface device 130 to be wirelessly coupled to one or more computing devices. The communication system is shown in FIG. 2 comprising wireless antenna 250 and wireless transceiver 255, which may comprise a Bluetooth antenna. Although Bluetooth communication is specifically mentioned, other wireless communication protocols may be used.

The network interface device 130 may also include the various other circuits and components shown in FIG. 2, such as internal debug ports 272 and other storage, processing and communications mechanisms.

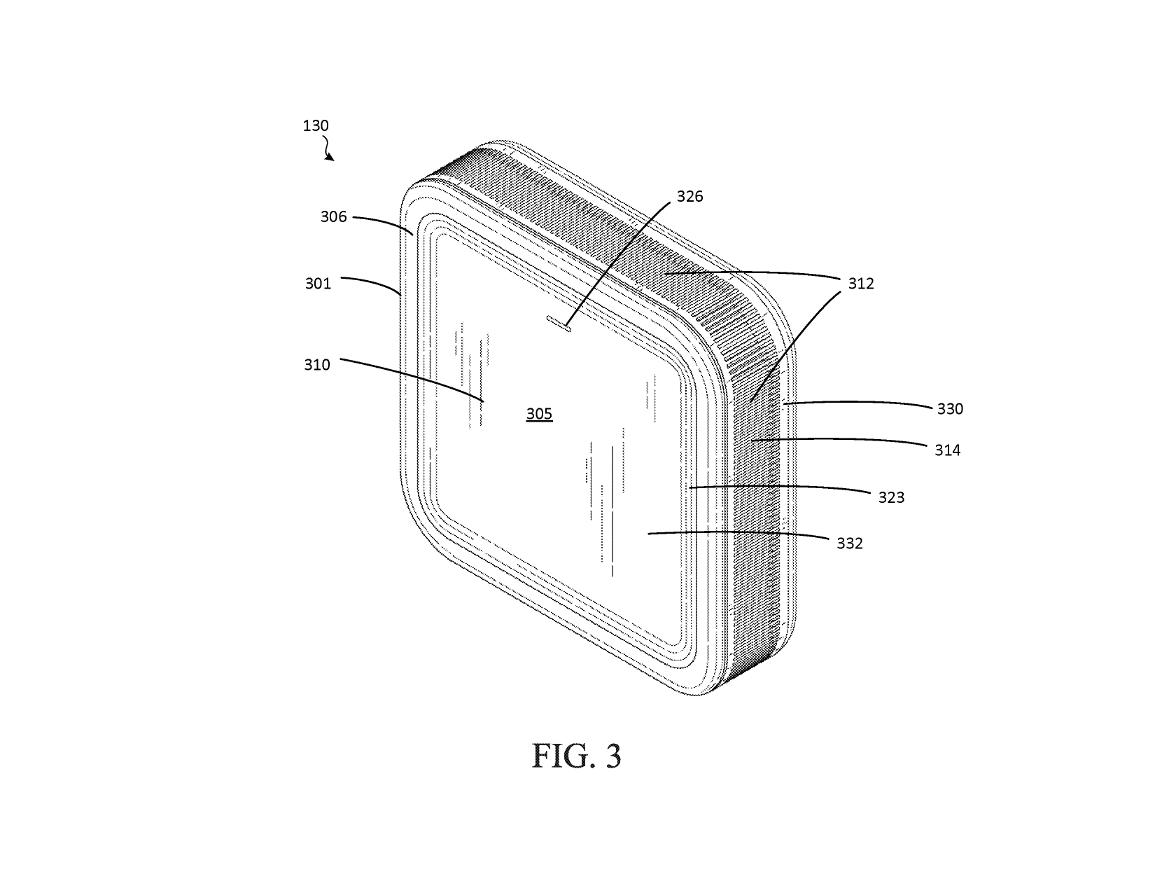

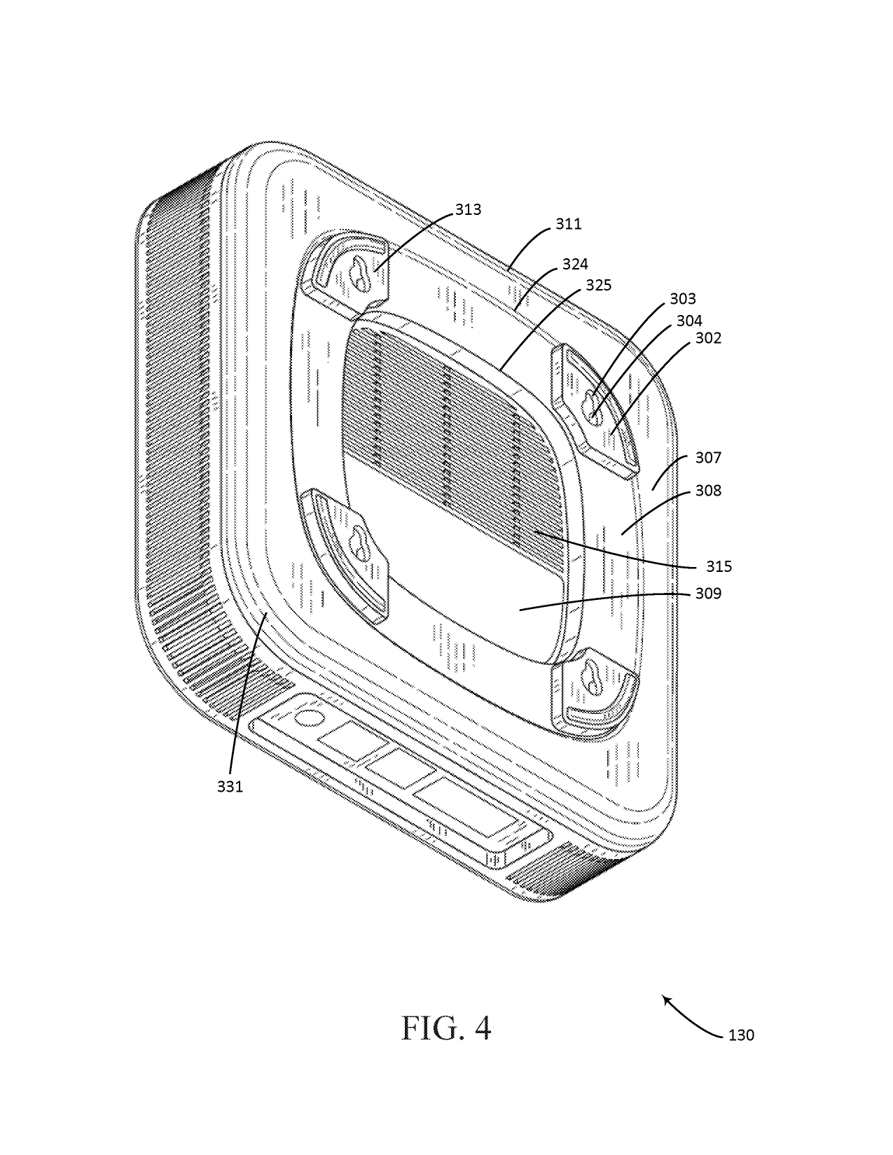

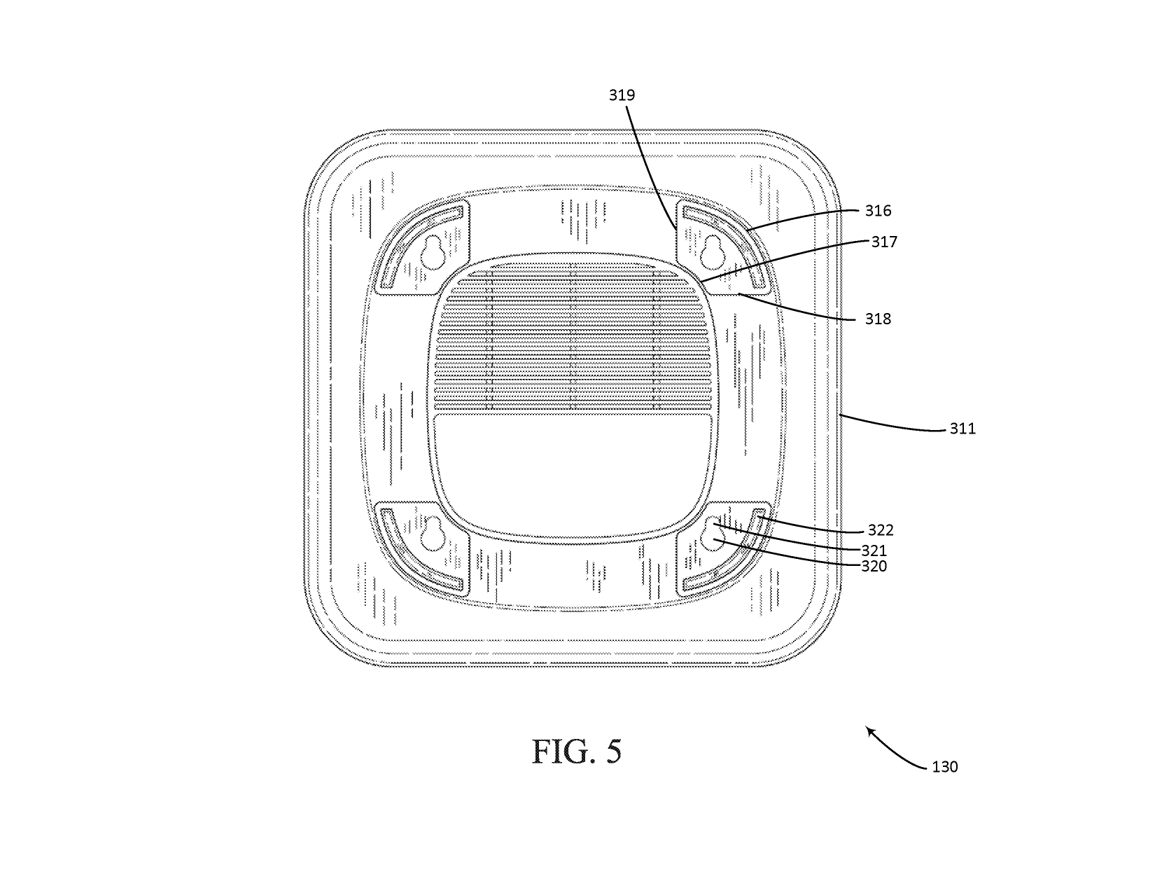

FIG. 3 illustrates a front isometric view of a network interface device 130 according to an example and FIG. 4 illustrates a rear isometric view of the network interface device 130 of FIG. 3 according to an example. FIG. 5 illustrates a bottom view of the network interface device 130 according to an example. FIG. 6 illustrates a side view of the network interface device 130 according to an example.

Referring concurrently to FIGS. 3-6, network interface device 130 may include housing 301. In some examples, housing 301 may be made of about 60% recycled plastic. Housing 301 may include top housing portion 310 and bottom housing portion 311 (FIG. 4). Top housing portion 310 may include top surface 306, top light 326, top fillet surface 323, and top indented surface 305 indented in the housing. Bottom housing portion 311 may include legs 302, keyholes 303, bottom surface 307, first bottom indented surface 308, second bottom indented surface 309, first bottom indented edge 324, second bottom indented edge 325, and bottom air vents 315. The top housing portion 310 may be connected to the bottom housing portion 311 by side housing portion 312. Side air vents 314 (FIG. 3) may wrap around at least a portion of network interface device 130 (e.g., may be disposed in or on side housing portion 312). Port cavity 327 (FIG. 6) may also be disposed on side housing portion 312, and may include communication ports 230 (e.g., power port 328). Port cavity 327 may additionally include reset button 222. Keyholes 303 may connect to cavities 304 formed at least partially in legs 302. Keyholes 303 may each comprise a first keyhole portion 320, and second keyhole portion 321. Legs 302 may include bottom leg surfaces 313, outside leg edge 316, inside leg edge 317, first leg side edge 318, and second leg side edge 319. Curved strip 322 (e.g., FIGS. 5, 6) may be attached to at least one leg of legs 302, and in the example shown, multiple curved strips 322 are present, each attached to one of the legs 322. A central plane (CP) may be defined (see, e.g., FIG. 6) approximately halfway between a top plane (TP) tangential to the most distal portion of the top surface 306 and a bottom plane (BP) tangential to the most distal portion of bottom surface 307. In examples, a leg plane (LP) may be defined as tangential to the most distal portions of bottom leg surfaces 313, and bottom plane BP may be separated from leg plane LP by gap 329 (FIG. 6). In addition, curved strips 322 may extend farther from the CP than the BP.

Top housing portion 310 (FIG. 3) may be defined by a portion of housing 301 that is generally located at the top of housing 301 when network interface device 130 is placed on a surface with legs 302 contacting the surface and supporting network interface device 130. Top housing portion 310 may be opposite of bottom housing portion 311, and bottom housing portion may be defined by a portion of housing 301 that is generally located at the bottom of housing 301 when network interface device 130 is placed on a surface with legs 302 contacting the surface and supporting network interface device 130. For example, bottom housing portion 311 may be shown in FIG. 5. Side housing portion 312 may be substantially adjacent to, and connecting, top housing portion 310 and bottom housing portion 311.

Top surface 306 may be disposed around an outside or around a perimeter of top housing portion 310. Top surface 306 may be substantially adjacent to side housing portion 312. For example, at least a portion of top surface 306 may be substantially adjacent to side surfaces 330 of side housing portion 312 and top indented surface 305 of top housing portion 310. Top indented surface 305 is an indented and substantially flat surface on top housing portion 310. Top indented surface 305 may cover a majority of the surface area of top housing portion 310. In some examples, top surface 306 may be or may include a curved surface. Top indented surface 305 may define a top recess 332 in top housing portion 310. In some examples, the depth of top recess 332 (e.g., defined by a distance from a plane defined by top surface 306 to a plane defined by top indented surface 305) may be less than the depth of gap 329 to allow for airflow to flow out from under/in under another network interface device 130 or another device positioned on top of and in top recess 332 (e.g., when both devices are stacked).

Top fillet surface 323 is a concave fillet surface that connects top surface 306 and top indented surface 305. Top fillet surface 323 may be substantially adjacent to top surface 306 and top indented surface 305. Top fillet surface 323 may form a single continuous surface with top indented surface 305.

Top light 326 is a light that is disposed in top housing portion 310 (e.g., located on or in top indented surface 305). Top light 326 may comprise a light emitting diode (among other possibilities) and may indicate that network interface device 130 is turned on, has power, is connected to a network, or a combination of these (e.g., depending on color and/or brightness of top light 326).

Bottom surface 307 (FIG. 4) may be disposed around an outside or around a perimeter of bottom housing portion 311. Bottom surface 307 may be a substantially flat surface. Bottom surface 307 may be substantially adjacent to bottom fillet surface 331, which may be substantially adjacent to side housing portions 312. Bottom surface 307 may be substantially perpendicular to side surfaces 330 of side housing portion 312. Bottom surface 307 may be substantially parallel to top indented surface 305, first bottom indented surface 308, second bottom indented surface 309, or a combination of these. First bottom indented surface 308 is an indented and substantially flat surface on bottom housing portion 311. Second bottom indented surface 309 is an indented and substantially flat surface on bottom housing portion 311. Second bottom indented surface 309 may be indented into housing 301 more than first bottom indented surface 308. Bottom surface 307 may be located closer to side housing portion 312 than first bottom indented surface 308, which may be located closer to side housing portion 312 than second bottom indented surface 309. That is, bottom surface 307 may be located more on the outside of bottom housing portion 311 than first bottom indented surface 308, which may be located more on the outside of bottom housing portion 311 than second bottom indented surface 309. First bottom indented edge 324 is disposed between bottom surface 307 and first bottom indented surface 308. Second bottom indented edge 325 is disposed between first bottom indented surface 308 and second bottom indented surface 309. Bottom housing portion 311 may include bottom air vents 315 which may be located substantially adjacent to second bottom indented surface 309. Bottom air vents 315 may function to facilitate airflow created by one or more fans 273 internal to network interface device 130 that are configured to cool circuitry included in network interface device 130.

In examples, legs 302 may comprise protrusions from first bottom indented surface 308. Legs 302 may be disposed on bottom housing portion 311. Legs 302 may extend substantially perpendicularly from first bottom indented surface 308. Network interface device 130 may include any number of legs (e.g., three, four, five, six, or more legs 302). Four legs depicted in the Figures is just one example of the number of legs 302 that network interface device 130 may include. Legs 302 include bottom leg surfaces 313, which may be substantially flat surfaces on the bottoms of legs 302. In some examples, there may be a gap 329 between the bottom plane (BP) and leg plane (LP), as shown in FIG. 6. Gap 329 may serve to allow for airflow to or from bottom air vents 315. Additionally or alternatively, gap 329 may allow for space for network interface device 130 to stand, using legs 302, on another network interface device 130. For example, legs 302 may fit into the cavity created by top indented surface 305 on the other network interface device 130. As such, legs 302 may stand on top indented surface 305 and/or top fillet surface 323 on the other network interface device 130. In examples, the gap 329 is larger than the difference in distance away from the central plane (CP) between top surface 306 and top indented surface 305 such that when two network interface devices 130 are stacked on top of one another, there is still a gap between the top surface 306 of the lower network interface device 130 and the bottom surface 307 to allow for air flow.

Outside leg edges 316 (FIG. 5) may be defined by curved edges on the outside of bottom leg surfaces 313 that allow network interface device 130 to stand, using legs 302, on another network interface device 130. For example, the outside leg edges may be positioned close enough to each other that all four legs can fit within top indented surface 305, allowing multiple network interface devices 130 to be stacked. That is a perimeter defined by the plurality of legs 302 is smaller than a perimeter of the top indented portion 305. Inside leg edges 317 are curved edges on the inside of bottom leg surfaces 313. In some examples, inside leg edges 317 may approximately follow the curvature of the corners of second bottom indented edge 325 so that legs 302 do not extend past second bottom indented edge 325 (e.g., or extend up or nearly up to second bottom indented edge 325).

First leg side edges 318 and second leg side edges 319 are substantially straight edges that connect outside leg edges 316 and inside leg edges 317. As such, the cross-sectional shapes of legs 302 may be crescents or truncated crescents.

Curved strips 322 may comprise strips of frictional material (e.g., rubber) designed to grip a surface on which network interface device 130 may stand or rest against using legs 302. Curved strips 322 may be located closer to outside leg edges 316 than inside leg edges 317. Curved strips 322 may be made of a different material (such as rubber) than housing 301 or its components and may be attached to housing 301 using adhesive or other methods. In addition, the curved strips may extend farther from central plane (CP) than leg plane (LP), in examples.

Keyholes 303 (FIG. 4) may comprise elongated openings cut into legs 302, designed to accommodate a fastener or protrusion for mounting on a securing surface (e.g., a vertical surface) or on a stand. In examples, a securing surface is provided with protrusions that include a larger portion (e.g., a head of a screw) and a smaller portion (e.g., a post or threaded portion of a screw). In examples, the protrusions may be mounted or otherwise configured directly into a wall, on a stand, and/or on a mounting plate that can, itself, be mounted to a vertical surface. Keyholes 303 may be disposed at the bottom of legs 302 (e.g., in bottom leg surfaces 313). In examples, bottom leg surfaces 313 are not as deep as the gap 329, and the space within the interiors of legs 302 between the bottom leg surfaces 313 and the bottom plane (BP) is considered part of cavities 304. In some examples, cavities 304 may also extend past the bottom plane (BP) (towards the central plane (CP)). In some examples, each leg 302 may include one keyhole 303. Keyholes 303 allow for network interface device 130 to be mounted on a wall (with or without a mounting plate), a stand, or any other component. That is, in examples, keyholes 303 enable the network interface device 130 to be removably coupled to various protrusions of a securing surface, such as a wall, a stand, or the like. Cavities 304 may be defined behind keyholes 303 (towards the central plane (CP)). That is keyholes 303 define openings leading to cavities 304), which comprise hollow spaces within legs 302 that extend from keyholes 303, providing a secure anchor for the fastener or protrusion. First keyhole portions 320 and second keyhole portions 321 are respective portions of keyholes 303. First keyhole portions 320 are openings designed to receive larger portions (e.g., heads) of protrusions (which may also be referred to as fasteners). The second keyhole portions 321, which are openings adjacent to first keyhole portions 320 and are typically smaller than first keyhole portions 320 and smaller than the larger portions (e.g., heads) of protrusions. Smaller keyhole portions 321 may be configured to receive the posts of the protrusions (e.g., the threaded portion of a screw). In some examples, keyholes 303 are raised (farther from central plane (CP)) relative to bottom surface 307, and each cavity 304 is deep enough that the head of a protrusion (e.g., the head of a screw) can fit entirely within the cavity 304 when the protrusion head is received through the first portion 320 of the keyhole 303 and when the post of the protrusion (e.g., a threaded portion of a screw) is received by the second portion 321 of the keyhole 303. Network interface device 130 may be mounted by first placing the first portions 320 of keyholes 303 over protrusions that protrude from a securing surface. The network interface device 130 may then be moved relative to the protrusions (e.g., slid along the securing surface), such that the larger portions (e.g., heads) of the protrusions remain within the cavities 304, while the smaller portions (e.g., posts) of the protrusions are received into second keyhole portions 321. In examples where the network interface device 130 is being mounted vertically, the second portions 321 of the keyholes 303 may be oriented above the first portions 320 such that gravity helps to hold the network interface device 130 in place, while the larger portions (e.g., heads) of the protrusions are trapped in cavities 304, unable to pull through the smaller portions 321 of the keyholes 303. In examples, all keyholes 303 are oriented in a same direction with the larger portion 320 closer to port cavity 327 than the smaller portion 321. This allows the network interface device 130 to be secured on a vertical surface with the wires from the ports coming out the bottom of the network interface device 130. This arrangement also allows the network interface device 130 to be secured on a stand (e.g., with just two keyholes), with any connected wires coming out the bottom of the stand, as will be described.

Side surfaces 330 (FIG. 3) may include substantially flat surfaces located on side housing portion 312. At least some portions of side surfaces may be perpendicular to bottom surface 307 and/or top indented surface 305. Side surfaces 330 may include curved surfaces, for example, at the corners of network interface device 130.

Side air vents 314 are located at side housing portion 312. In some examples, side air vents 314 may wrap around an entirety of side housing portion 312 except for (or including) port cavity 327. Side air vents 314 may be disposed in or adjacent to side surfaces 330. Side air vents 314 may function to facilitate airflow created by one or more fans 273 internal to network interface device 130 that are configured to cool circuitry included in network interface device 130.

Port cavity 327 (e.g., a pocket) (FIG. 6) is a recessed cavity in a side of side housing portion 312. Port cavity 327 may include openings for communication ports 230, reset button 222, power port 328, or a combination of these, among other ports or features.

Communication ports 230 are designed to receive and/or transmit wired electrical communication signals. One or more of communication ports 230 may be used to communicatively couple the network interface device 130 to access a network provided by a network service provider. In an example, one or more of communication ports 230 may be a DSL port, a SFP (a small form-factor pluggable) port, a cable port, a phone port and the like.

In an example, one or more of communication ports 230 may be configured to support different connection types. For example, if an entity is located in an area in which fiber-optic cables are used to provide network access, the one or more of communication ports 230 may be a first type of communication port (e.g., a communication port that supports fiber-optic communications/signals). However, if the entity is located in an area in which copper cables are used to provide network access, the one or more of communication ports 230 may be a second type of communication port (e.g., a communication port that supports communications/signals via copper cables). In another example, the one or more of communication ports 230 may support communications/signals from fiber-optic cables and copper cables. In yet another example, the one or more of communication ports 230 may receive a transceiver that enables the transmission of data from a connected device to the network interface device 130.

Network interface device 130 may also include a second one or more of communication ports 230. The second one or more of communication ports 230 may be used to communicatively couple the network interface device 130 to a network access device (e.g., network access device 140 (FIG. 1)). In examples, one or more of communication ports 230 may be operatively connected to processor 214 through one or more switching devices 245.

Network interface device 130 may also include a communication system that enables network interface device 130 to be wirelessly coupled to one or more computing devices. The communication system is shown in FIG. 2 comprising wireless antenna 250 and wireless transceiver 255, which may comprise a Bluetooth antenna. Although Bluetooth communication is specifically mentioned, other wireless communication protocols may be used.

Communication ports 230-a (e.g., 1GE (Gigabit Ethernet) LAN ports) may be designed to receive and/or transmit wired electrical communication signals (e.g., at a rate of 1 Gbps). Communication ports 230-a may be primarily used for connecting the network interface device 130 to devices within a local area network. Communication ports 230-a may be suitable for many common networking applications. In an example, communication port 230-a may be used to connect the network interface device 130 to a desktop computer, a printer, or a server.

Communication ports 230-a may be used to communicatively couple the network interface device 130 to access a network provided by the network service provider. In some examples, communication ports 230-a may include one or more ports (e.g., two ports).

In an example, communication ports 230-a may be configured to support different connection types. For example, if an entity (e.g., entity 150 (FIG. 1)) is located in an area in which fiber-optic cables are used to provide network access, communication ports 230-a may be a first type of communication port (e.g., a communication port that supports fiber-optic communications/signals). However, if the entity is located in an area in which copper cables are used to provide network access, communication ports 230-a may be a second type of communication port (e.g., a communication port that supports communications/signals via copper cables). In another example, communication ports 230-a may support communications/signals from fiber-optic cables and copper cables. In yet another example, communication ports 230-a may receive a transceiver that enables the transmission of data from a connected device to the network interface device 130.

Communication port 230-b (e.g., a 10GE LAN port) may be designed to receive and/or transmit wired electrical communication signals (e.g., at a rate of 10 Gbps). Communication port 230-b may be used within a local area network. Communication port 230-b may be used to connect the network interface device 130 to other devices within the same physical location, such as servers, workstations, and storage devices. In an example, communication port 230-b may be used to connect the network interface device 130 to a high-speed network switch that provides connectivity to multiple devices within a data center or office. Communication port 230-b may be used to communicatively couple the network interface device 130 to a network access device (e.g., network access device 140 (FIG. 1)).

Communication port 230-c (e.g., a 10GE WAN/LAN port) may be designed to receive and/or transmit wired electrical communication signals (e.g., at a rate of 10 gigabits per second (Gbps)). Communication port 230-c may be used to establish a connection between the network interface device 130 and a WAN provided by a network service provider, or a local area network (LAN) within the same physical location. In an example, communication port 230-c may be used to connect the network interface device 130 to a copper or fiber optic cable that provides a high-bandwidth connection to the internet or a corporate network.

Reset button 222 may be designed to restore network interface device 130’s settings and/or network connections to their original factory-defined state. When pressed, reset button 222 may effectively disconnect network interface device 130 from any existing WAN or LAN connections established through communication ports 230-a, 230-b, and 230-c. Resetting may cause network interface device 130 to re-establish network connectivity and apply default settings for network configuration, security, and other relevant parameters. Additionally or alternatively, reset button 222 may also help resolve minor software issues or configuration errors that may be affecting the performance of network interface device 130.

Power port 328 is designed to receive wired power input to power network interface device 130.

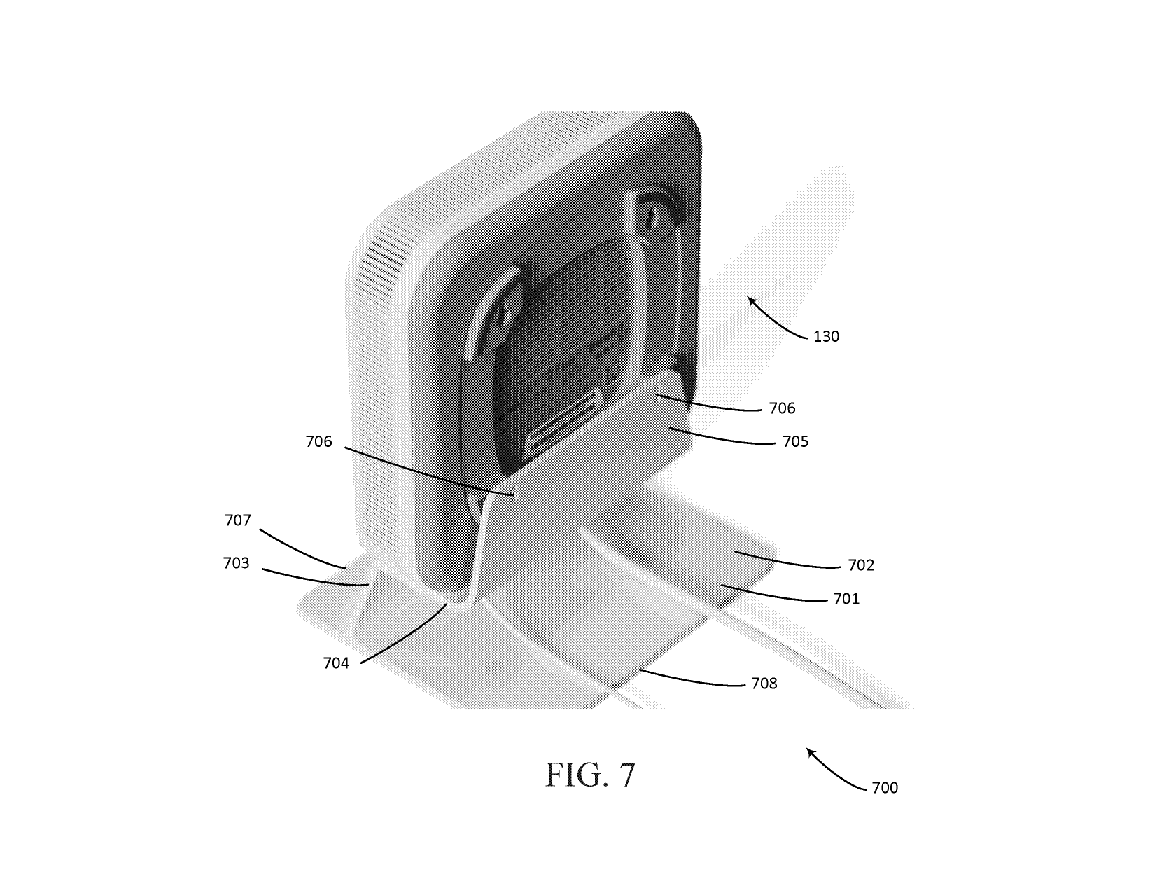

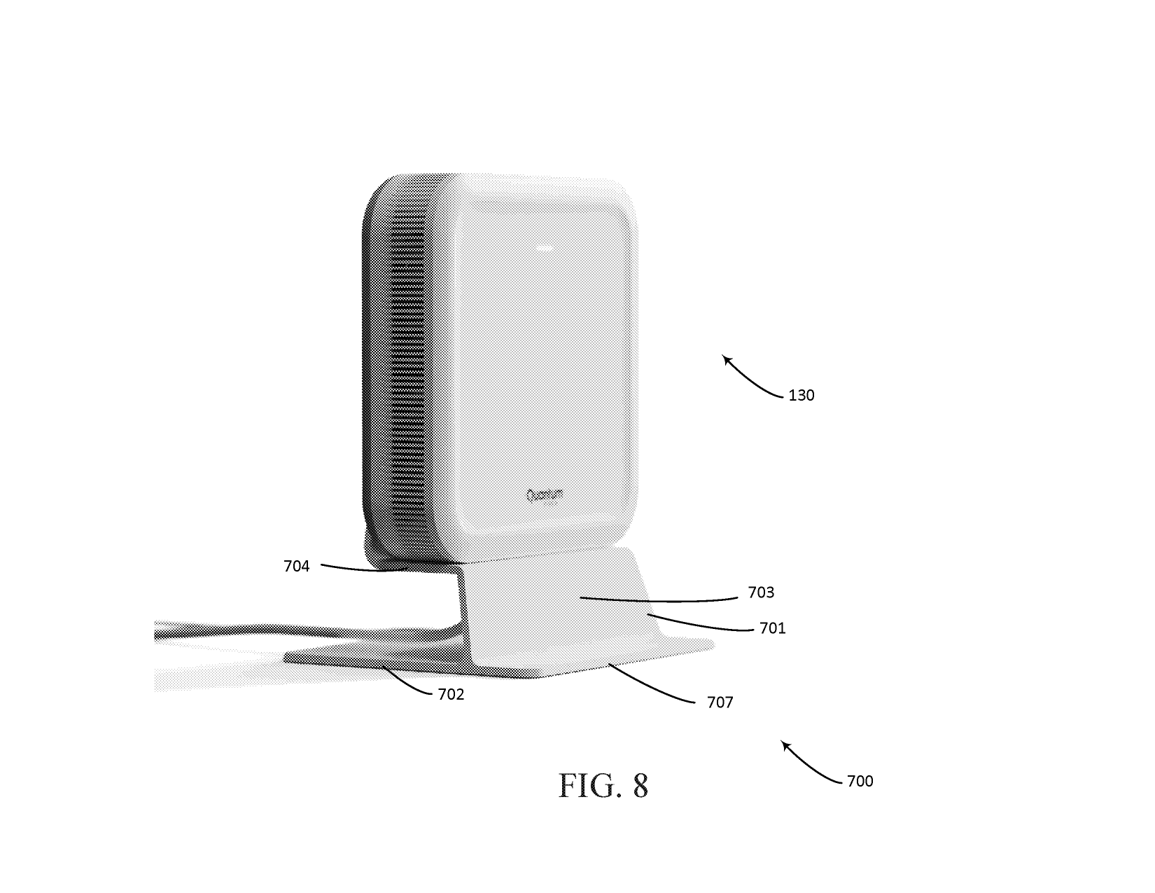

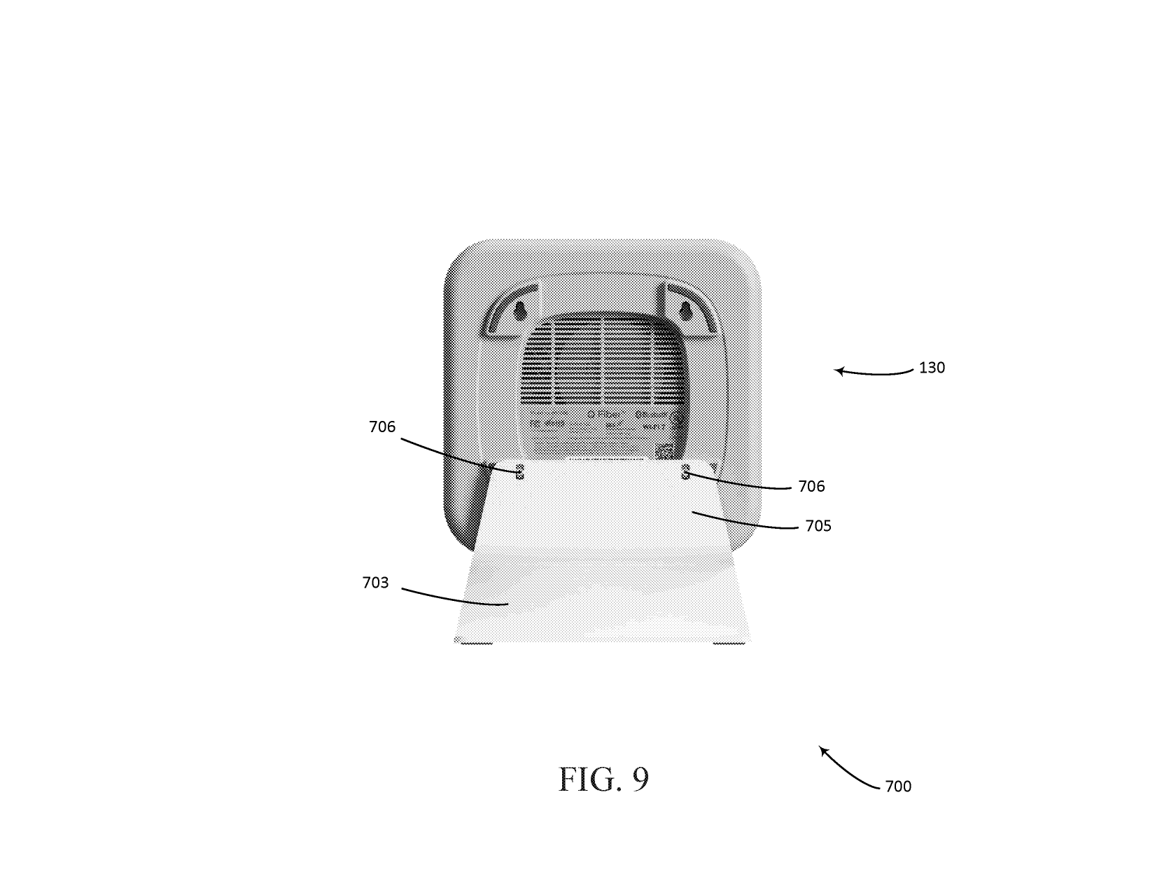

Referring to FIGS. 7-9, network interface device 130 may be configured to be mounted on stand 701 to form stand assembly 700. For example, stand 701 may include protrusions 706 that are received by one or more (e.g., two) keyholes 303, such as the keyholes 303 that are closest to the port cavity 327. In some examples, network interface device 130 may be oriented with the side corresponding to port cavity 327 facing down such that the wires extending from the ports of port cavity 327 extend downwards (FIG. 7, FIG. 9). For example, stand 701 may include a vertical support portion 703 that extends down below and substantially in front of port cavity 327 such that the wires that extend down from port cavity 327 are hidden from a front view when network interface device 130 is mounted on stand 701 in this orientation.

Stand 701 may include a base 702 configured to rest substantially horizontally on a flat surface. Stand 701 may include vertical support portion 703 that extends substantially perpendicularly from base 702. Vertical support portion 703 may be disposed proximal to a front edge 707 of base 701, for example, disposed in a front half of base 701 closer to front edge 707 than rear edge 708. Stand 701 may include device support portion 704 oriented substantially horizontally (e.g., substantially parallel to base 702) and extending backwards (e.g., in a direction opposite of front edge 707 with respect to base 702) from a distal edge of vertical support portion 703 (e.g., distal relative to base 702). In this way, when network interface device 130 rests on device support portion 704, network interface device 130 may be disposed substantially in the middle of stand 701 (e.g., in the middle of base 702). Stand 701 may include back device support portion 705 extending substantially vertically from device support portion 704. Protrusions 706 may be integrally formed with back device support portion 705 or may be removably secured to back device support portion 705. Back device support portion 705 may be disposed at an edge of device support portion 704 substantially opposite from the edge where device support portion 704 and vertical support portion 703 intersect. As such, vertical support portion 703, device support portion 704, and back device support portion 705 may form a rotated “Z” shape cross-section. In some examples, device support portion 704 may include one or more apertures to receive wires extending out from port cavity 327.

Network interface device 130 may be mounted to stand 701 by first placing the first portions 320 of keyholes 303 over protrusions 706 that protrude from back device support portion 705. The network interface device 130 may then be moved relative to the protrusions 706 (e.g., slid along the back device support portion 705), such that the larger portions (e.g., heads) of the protrusions remain within the cavities 304, while the smaller portions (e.g., posts) of the protrusions are received into second keyhole portions 321. Because the second portions 321 of the keyholes 303 may be oriented above the first portions 320, the network interface device 130 may be secured in place (and resist tipping over) because larger portions (e.g., heads) of the protrusions 706 are trapped in cavities 304, unable to pull through the smaller portions 321 of the keyholes 303.

In this manner, network interface device 130 may be laid flat on a surface, secured to a wall, or secured to a stand, such as stand 701, without requiring different housings for each intended orientation.

As will be understood by those of skill in the art, any reference to “top,” “bottom,” “front,” “rear,” “side,” etc. are used to describe various components of network interface device 130 when in the orientation shown, for example, in the figures, or alternatively with respect to an orientation when network interface device 130 is placed on a typical ground surface with legs 302 supporting network interface device 130 on the ground surface; however, the components described herein can be utilized in a variety of orientations, depending on the surface(s) to which network interface device 130 is installed.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Those skilled in the art will recognize that the methods and systems of the present disclosure may be implemented in many manners and as such are not to be limited by the foregoing aspects and examples. In this regard, any number of the features of the different aspects described herein may be combined into single or multiple aspects, and alternate aspects having fewer than or more than all of the features herein described are possible. Functionality may also be, in whole or in part, distributed among multiple components, in manners now known or to become known.

Moreover, the scope of the present disclosure covers conventionally known manners for carrying out the described features and functions, and those variations and modifications that may be made to the components described herein as would be understood by those skilled in the art now and hereafter. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

Further, as used herein and in the claims, the phrase “at least one of element A, element B, or element C” is intended to convey any of: element A, element B, element C, elements A and B, elements A and C, elements B and C, and elements A, B, and C. In addition, one having skill in the art will understand the degree to which terms such as “about,” “approximately,” or “substantially” convey in light of the measurement techniques utilized herein. To the extent such terms may not be clearly defined or understood by one having skill in the art, the terms “about,” “substantially,” or “approximately,” shall mean plus or minus ten percent, and when used with respect to angular measurements, the term “substantially” shall mean within plus or minus ten degrees (e.g., “substantially perpendicular” shall mean within ten degrees from exactly perpendicular, and “substantially parallel” shall mean within ten degrees from exactly parallel).

Numerous other changes may be made which will readily suggest themselves to those skilled in the art and which are encompassed in the spirit of the disclosure and as defined in the appended claims. While various aspects have been described for purposes of this disclosure, various changes and modifications may be made which are well within the scope of the disclosure. Numerous other changes may be made which will readily suggest themselves to those skilled in the art and which are encompassed in the spirit of the disclosure and as defined in the claims.

What is claimed is:

1. A network interface device, comprising:
a housing comprising a top housing portion and a bottom housing portion opposite the first housing portion, wherein the top housing portion comprises a top indented surface;
a plurality of legs disposed on the bottom housing portion; and
a plurality of keyholes, wherein each keyhole of the plurality of keyholes is disposed in a respective leg of the plurality of legs.

2. The network interface device of claim 1, wherein a leg plane defined as tangential to a most distal portion of at least one leg of the plurality of legs is separated by a gap from a bottom plane defined as tangential to a bottom surface of the bottom housing portion.

3. The network interface device of claim 1, wherein the bottom housing portion comprises a plurality of bottom air vents, and the housing further comprises a side housing portion comprising a plurality of side air vents.

4. The network interface device of claim 1, wherein the housing further comprises a pocket indented in a side housing portion, and wherein a plurality of openings for communication ports are disposed in the pocket.

5. The network interface device of claim 4, wherein each of the keyholes comprises a first keyhole portion and a second keyhole portion, wherein each first keyhole portion is larger than each second keyhole portion, and wherein each first keyhole portion is disposed closer to the pocket than its respective second keyhole portion for all of the keyholes.

6. The network interface device of claim 1, wherein the bottom housing portion comprises a bottom surface, a first bottom indented surface indented in the housing, and a second bottom indented surface indented in the housing more than the first bottom indented surface.

7. The network interface device of claim 6, wherein each of the plurality of legs is disposed on the first bottom indented surface.

8. The network interface device of claim 1, wherein each of the keyholes comprises a first keyhole portion and a second keyhole portion, wherein each first keyhole portion is larger than each second keyhole portion, and wherein all keyholes are oriented in a same direction such that the first keyhole portion is disposed on a same side of its respective second keyhole portion.

9. The network interface device of claim 2, wherein the top indented surface is indented from a most-distal portion of the top housing portion by a first distance, and wherein the legs extend farther from the bottom plane than the first distance.

10. The network interface device of claim 1, wherein the network interface device comprises circuitry and at least one fan configured to cool the circuitry.

11. The network interface device of claim 1, wherein a cavity is disposed behind each keyhole of the plurality of keyholes, and wherein each cavity is defined at least partially by the respective leg in which the keyhole is disposed.

12. The network interface device of claim 1, wherein a perimeter defined by the plurality of legs is smaller than a perimeter of the top indented portion.

13. A network interface device, comprising:
a housing comprising a bottom surface, a first bottom indented surface indented in the housing, and a second bottom indented surface indented in the housing more than the first bottom indented surface;
a plurality of legs disposed on the first bottom indented surface; and
a plurality of keyholes, wherein each keyhole of the plurality of keyholes is disposed in a respective leg of the plurality of legs.

14. The network interface device of claim 13, wherein a leg plane defined as tangential to a most distal portion of at least one leg of the plurality of legs is separated by a gap from a bottom plane defined as tangential to a bottom surface of the bottom housing portion.

15. The network interface device of claim 13, wherein a bottom housing portion of the housing comprises a plurality of bottom air vents, wherein the bottom housing portion comprises the bottom surface, the first bottom indented surface, and the second bottom indented surface, and wherein the plurality of bottom air vents is adjacent to the second bottom indented surface.

16. The network interface device of claim 13, wherein the housing further comprises a side housing portion comprising a plurality of side air vents.

17. A network interface device, comprising:
a housing;
a plurality of communication ports disposed within the housing;
a plurality of legs disposed on the housing; and
a plurality of keyholes, wherein each keyhole of the plurality of keyholes is disposed on a respective bottom leg surface of a respective leg of the plurality of legs.

18. The network interface device of claim 17, wherein a leg plane defined as tangential to a most distal portion of at least one leg of the plurality of legs is separated by a gap from a bottom plane defined as tangential to a bottom surface of the housing.

19. The network interface device of claim 17, wherein the plurality of openings for communication ports are disposed in a pocket in a side housing portion of the housing.

20. The network interface device of claim 17, wherein the plurality of legs are disposed on a first bottom indented surface of the housing.
